(19) United States
(12) Patent Application Publication
(10) Pub. No.: US 2008/0176076 A1
(43) Pub. Date: Jul. 24, 2008

(54) FUNCTIONALIZED LANTHANIDE RICH NANOPARTICLES AND USE THEREOF

(75) Inventors: Franciscus Cornelis Jacobus Maria van Veggel, Victoria (CA); Sri Sivakumar, Tamilnadu (IN); Peter R. Diamente, Nanaimo (CA)

Correspondence Address: KLARQUIST SPARKMAN, LLP, 121 SW SALMON STREET, SUITE 1600, PORTLAND, OR, 97204, US

(73) Assignee: University of Victoria Innovation and Development Corporation

(21) Appl. No.: 11/747,770

(22) Filed: May 11, 2007

Related U.S. Application Data
(60) Provisional application No. 60/799,965, filed on May 11, 2006.

(51) Int. Cl. B32B 15/02

(52) U.S. Cl. 428/404; 428/403; 977/773

(57) ABSTRACT

A functionalized nanoparticle is provided that comprises a nanoparticle synthesized from a mixture comprising lanthanide ions, a coating of silica or related materials and a presenting substrate. The presenting substrate can be conjugated to the nanoparticle for functionalizing the nanoparticle. The functionalized nanoparticle is less than about 350 nm in diameter.

### CROSS REFERENCE TO RELATED APPLICATION

This application claims benefit of U.S. Provisional Patent Application No. 60/799,965 filed May 11, 2006, and entitled “FUNCTIONALIZED LANTHANIDE RICH NANOPARTICLES AND USE THEREOF” which is hereby incorporated herein by reference.

### FIELD

The technology relates to nanoparticles that are prepared from lanthanide rich nanoparticles and a coating to provide a product nanoparticle, which in turn can be conjugated to a selected material. The technology also relates to methods of using functionalized nanoparticles.

### BACKGROUND

There is a large interest in the development of highly luminescent biomaterials for biological applications such as biolabeling, drug delivery, diagnostics of infectious and genetic diseases, etc.^{[1]} Materials such as traditional organic dyes^{[2]}, quantum dots^{[3]}, and metal nanoparticles^{[4]} are widely applied in biological analyses but have some limitations. Organic dyes have a number of known drawbacks such as weak photostability, broad absorption and emission band, and toxicity.^{[2]} Various semiconductor quantum dots display high photostability, size dependant emission, high quantum yields, and narrow emission bandwidth and have successfully been applied in biological applications.^{[3]} However, they are still controversial because of their inherent toxicity and chemical instability.^{[5]} Moreover, their inherent short-lived luminescent lifetime may overlap with the spontaneous background emission sources (natural fluorescence of biomolecules such as proteins is within 1-10 ns). Noble metal nanoparticles (e.g. gold nanoparticles) which are known to scatter and absorb visible light make them potentially suitable candidates for biosensors.^{[4]} Though these noble metal nanoparticles posses biocompatibility, their optical properties in the visible region may overlap with natural proteins. Halas et al.^{[6]} have addressed this issue in a different way by developing a gold nanoshell over a silica sphere of sub-micron size for bio-applications such as the integration of cancer imaging and therapy. Notwithstanding this progress, there is still a need for more efficient biolabels with high photostability, biocompatibility, optical properties, and ultrasensitivity to bioassays.

In order to address these key issues, the development of an alternative biomaterial via lanthanide-doped nanoparticle is gaining popularity due to their unique luminescent properties such as sharp absorption and emission lines, high quantum yield, long lifetimes and superior photostability.^{[7]} In particular, lanthanide ions are known to exhibit both efficient energy down- and up-conversion emission properties, where the down-conversion process is the conversion of higher energy photons into lower energy photons, which is also widely exploited in quantum dots as well as in organic dyes.^{[8]} In contrast, the up-conversion process converts lower energy photons via multiphoton processes into higher energy photons, and is, in general, based on sequential absorption and energy transfer steps.^{[9]} One has to bear in mind that this event is different from multiphoton absorption processes, which typically require high excitation densities.^{[9]}

At present, there are only a select number of reports on the use of lanthanide-based nanoparticles as potential biolabels that emit in the visible region, by either up-conversion or down-conversion processes.^{[5]} Examples include the bioconjugation of Ln³⁺-doped LaF₃ nanoparticle to avidin by our group^{[10]}, and work done by Caruso and co-workers^{[11]} with the functionalization of LaPO₄:Ce/Tb nanoparticles with streptavidin for biotin-streptavidin binding studies. In addition, a recent contribution from Li and co-workers^{[12]} demonstrate that an Er³⁺/Yb³⁺ up-converting nanoparticle label can be used in FRET type analysis, whereby the emission of the up-converting nanoparticle is quenched by the energy accepting gold nanoparticle that are functionalized with biotin for biotin-avidin detection and quantification. Although these articles prove the principle of bioconjugation, they have three main drawbacks. The first is long term stability where it has been reported that ionic bound stabilizing ligands can be protonated off the surface of the nanoparticles in pH-dependent solutions.^{[10]} The second is toxicity due to exposure of lanthanide ions to the body, and finally they emit only in the visible region. Only a few reports have dealt with these issues by developing a silica shell over the lanthanide-doped materials, such as, silica-coated YVO₄:Eu³⁺ nanoparticles functionalized with guanidinium for sodium channel targeting by Beaurepaire et al.^{[13]}, and silica-coated Gd₂O₃:Tb³⁺ nanoparticle functionalized with streptavidin by Louis et al.^{[14]} Additionally Niedbala and co-workers have done up-converting, silica-coated, lanthanide-doped submicron-sized ceramic particles for DNA assays.^{[15]} The use of a silica coating over lanthanide-doped nanoparticles is an attractive alternative because the surface chemistry of silica spheres is well documented and silica is known to have benign effects in biological systems.^{[16]} Up-converting and near-infrared (NIR) emitting biolabels with silica coating would be beneficial because up-converting materials can be excited with NIR light, which is outside the luminescent absorption range of biomolecules, thus minimizing loss of excitation energy to the surrounding material as compared to exciting with UV light.^{[5]} Furthermore, excitation and emission in the NIR region can minimize interferences from the autofluorescence of proteins. However, these reports only show emission in the visible region by a down-conversion process, and to the best of our knowledge, there are no reports available on silica-coated lanthanide-doped nanoparticles, which have near-infrared emission (750-2000 nm) and up-converted emission.

There are other disadvantages of the existing biolabels. First they suffer from quenching. Second they have a low range of emission lines. Third they suffer losses of excitation energy to the surrounding material because they are excited with UV light. Fourth, skin and other biological materials are not very transparent to UV-Vis light, thus deep penetration of light is difficult. Fifth there is interference from auto-fluorescence of proteins, nucleic acids and others cellular components. Sixth, some biolabels are not easily removed from the body for example by secretion through the kidneys. Seventh, low luminescent lifetimes, size-dependent emission (as in quantum dots), and instable photocycle.

Turning to telecommunications, in recent years, advances in Tm³⁺-doped materials for telecommunication devices have been used to expand the transmission bandwidth of optical fibers beyond the range available from Er³⁺-doped fiber amplifiers, by taking advantage of the 1.4 μm emission wavelength from Tm^{3+ [i]}. This need is a result of a surge of interest in increasing the traffic on wavelength-division multiplexing optical communication networks offered by installed silica-glass fibers. However, until recently the OH content in most fiber-optics prevented engineers from taking advantage of the S-band due to the sensitivity of Tm³⁺ to quenching. Now, the development of low-loss fibers has allowed Tm³⁺-doped fluoride or silica fiber amplifiers to produce effective amplifications from 1450 to 1520 nm^{[ii]. In addition to the} 1.4 μm emission band, a large amount of research is also being carried out to develop the 1.8 μm emission band of thulium, which has become of interest for light detection and ranging (LIDAR), remote sensing, and potential medical laser applications^{[iii]}.

Other important applications of Tm³⁺-doped materials have occurred in the field of nanoparticle up-conversion technology^{[iv,v,vi,vii,viii,ix]}, where excitation with low energy (e.g. near-infrared light) results in higher energy emission (e.g. visible region), and are being developed for, among others, display technology (flat screen display)^{iv,x}, blue laser diodes^{[xi]} and biolabel technology^{[xii,xiii,xiv,xv,xvi,xvii]}. Limited work has been published on the development of Tm³⁺-doped nanoparticles for near-infrared applications such as telecommunications and laser-diode technology. Work done by Higuchi et al.^{[xi]} have reported the preparation of LuVO₄ nanoparticles doped with Tm³⁺ by means of a floating zone method under pure oxygen, resulting in elongated crystals that exhibited emission at 1.8 μm. Other work by Lai et al.^{[xviii]} and Zhang et al.^{[x]} have developed Tm³⁺-doped (Y,Gd)P_{0.5}V_{0.5}O₄ and Tm³⁺-doped YVO₄ nanoparticles by co-precipitation and polymerizable complex methods, respectively, but they have only reported emission bands in the visible region. Work done by Riman et al.^{[xix]} have reported the development of LaCl₃ particles doped with Tm³⁺ at various concentrations and observed 1.47 μm emission, but no particle-size analysis was presented. To the best of our knowledge, there are no reports in the literature describing the preparation and spectral properties of processable Tm³⁺-doped nanoparticles that exhibit photoluminescence at 1.47 μm, and allow for easy surface modification to fine-tune their properties.

It is an object of the present technology to overcome the deficiencies in the prior art.

### SUMMARY

The preparation and bioconjugation of nearly monodisperse (approximately 40 nm) silica-coated LaF₃:Ln³⁺ nanoparticles is provided by this technology. Doping of the LaF₃ core with selected luminescent Ln³⁺ ions allows the particles to display a range of emission lines from the visible to the near-infrared region (450-1650 nm). First, the use of Tb³⁺ and Eu³⁺ ions resulted in green (541 nm), and red (591 and 612 nm), respectively, by energy down-conversion processes. Second, the use of Nd³⁺ gave 870, 1070 and 1350 nm emission lines, and Er³⁺ ion gave 1540 nm emission lines, respectively, by energy down-conversion processes. Additionally, the Er³⁺ ions gave green and red emission and Tm³⁺ ion gave 800 nm emission, via up-conversion processes when co-doped with Yb³⁺ (λₑₓ=980 nm). Bioconjugation of avidin, which is bound to fluorophore FITC as the reporter, was first done by surface modification of the silica particles with 3-aminopropyltrimethoxysilane, followed by the reaction of the biotin-N-hydroxysuccinimide activated ester to form an amide bond, imparting biological activity to the particles. A 25-fold increase in the FITC signal over the non-biotinylated silica particles indicates that there is minimal non-specific binding of FITC-avidin to the silica particles.

Also described is a general procedure for the synthesis of dispersible silica-coated, core-shell (LaF₃:Tm)LaF₃ nanoparticles with an average diameter of 40 nm and emission at 1.47 and 1.87 μm. Measurement of the citrate-stabilized precursor nanoparticles in D₂O exhibited 1.47 μm emission with an effective lifetime of 9 μs and an estimated quantum yield of <1%. Drastic improvements of the emission properties was done by forming a silica shell around the nanoparticles via a modified Stöber method, then curing at 900° C. for 24 hr. Excitation with a 785 nm CW diode laser resulted in the luminescence of the ³H₄-³F₄ transition at 1.47 μm with an effective lifetime of 151 μs and an increase in the estimated quantum yield to 10%. High-resolution measurements at 77 K were carried out in order to improve the resolution of the crystal field splitting observed from the ³F₄ level. Finally, 1.87 μm emission from the ³F₄-³H₆ transition was observed upon cooling to 77 K.

In one embodiment, a lanthanide rich product nanoparticle is provided. The product nanoparticle comprises:

a lanthanide rich precursor nanoparticle synthesized from a mixture comprising lanthanide ions; and
a coating comprising one or more of silica, alumina, zirconia, titania, hafnia, tantalum pentoxide, niobium pentoxide, germanium dioxide, Ln₂O₃ (Ln=La to Lu, Y, Sc), and MO2 (M=Be, Mg, Ca, Sr, Ba), wherein the product nanoparticle is less than about 350 nm in diameter.

In one aspect, the lanthanide ions are selected from the group consisting of Ce, Pr, Nd, Sm, Eu, Gd, Tb, Dy, Ho, Er, Tm, Yb, La, Lu, Y and Sc.

In another aspect, the mixture comprises at least two lanthanide ions.

In another aspect, the precursor nanoparticles are core-shell nanoparticles.

In another aspect, the precursor nanoparticles comprise a metal halide salt.

In another aspect, the precursor nanoparticles comprise a metal fluoride salt.

In another aspect, the shell comprises LaF₃.

In another aspect, the precursor nanoparticles comprise LaF₃:Ln (Ln=Er, Tb, Eu, Nd, or Tm).

In another aspect, the coating is silica.

In another aspect, the precursor nanoparticles comprise MF₂:Ln (M=Be, Mg, Ca, Sr, Ba; Ln=Ce, Pr, Nd, Sm, Eu, Gd, Tb, Dy, Ho, Er, Tm, Yb).

In another aspect, the precursor nanoparticles comprise M₁M₂F₄:Ln (M₁=Li, Na, K, Rb, Cs; M₂=La, Gd, Lu, Y, Sc; Ln=Ce, Pr, Nd, Sm, Eu, Gd, Tb, Dy, Ho, Er, Tm, Yb).

In another aspect, the lanthanide rich product nanoparticles range in size from about 5 to about 150 nm in diameter.

In another aspect, the lanthanide rich product nanoparticles range in size from about 5 to about 100 nm in diameter.

In another embodiment, a functionalized nanoparticle is provided. The functionalized nanoparticle comprises:

a product nanoparticle comprising:

a precursor nanoparticle synthesized from a mixture comprising lanthanide ions;

a coating comprising one or more of silica, alumina, zirconia, titania, hafnia, tantalum pentoxide, niobium pentoxide, germanium dioxide, Ln₂O₃ (Ln=La to Lu, Y, Sc), and MO2 (M=Be, Mg, Ca, Sr, Ba), to produce a product nanoparticle; and

a presenting substrate, the presenting substrate conjugated to the product nanoparticle for functionalizing the product nanoparticle, wherein the functionalized nanoparticle is less than about 350 nm in diameter.

In one aspect of the functionalized nanoparticle, the lanthanide ions are selected from the group consisting of Ce, Pr, Nd, Sm, Eu, Gd, Tb, Dy, Ho, Er, Tm, Yb, La, Lu, Y and Sc.

In another aspect of functionalized nanoparticle, the mixture comprises at least two lanthanide ions.

In another aspect of functionalized nanoparticle, the precursor nanoparticles are core-shell nanoparticles.

In another aspect of functionalized nanoparticle, the precursor nanoparticles comprise a metal halide salt.

In another aspect of functionalized nanoparticle, the precursor nanoparticles comprise a metal fluoride salt.

In another aspect of functionalized nanoparticle, the shell comprises LaF₃.

In another aspect of functionalized nanoparticle, the precursor nanoparticles comprise LaF₃:Ln (Ln=Er, Tb, Eu, Nd, or Tm).

In another aspect of functionalized nanoparticle, the coating is silica.

In another aspect of functionalized nanoparticle the presenting substrate is selected from the group consisting of avidin, streptavidin, biotin, antibody, polynucleotide, lectin, protein A, polypeptides and ligands selected from the group consisting of carboxylic acids and their esters, organo phosphorous compounds and their esters, phosphonates and phosphine oxides, alcohols, thiols, sulfoxides, sulfones, ketones, aldehydes, the group consisting of polymers of carboxylic acids and their esters, organo phosphorous compounds and their esters, phosphonates and phosphine oxides, alcohols, thiols, sulfoxides, sulfones, ketones, aldehydes the group consisting of and alkyl ammonium compounds (RNH³⁺, R₁R₂NH₂⁺, R₁R₂R₃NH⁺, R₁R₂R₃R₄N⁺, where R is independently selected from alkyl and aromatic groups.

In another aspect of functionalized nanoparticle, the presenting substrate is avidin.

In another aspect of functionalized nanoparticle the presenting substrate is surface modified.

In another aspect of functionalized nanoparticle the precursor nanoparticles comprise MF₂:Ln (M=Be, Mg, Ca, Sr, Ba; Ln=Ce, Pr, Nd, Sm, Eu, Gd, Tb, Dy, Ho, Er, Tm, Yb).

In another aspect of functionalized nanoparticle the precursor nanoparticles comprise M₁M₂F₄:Ln (M₁=Li, Na, K, Rb, Cs; M₂=La, Gd, Lu, Y, Sc; Ln=Ce, Pr, Nd, Sm, Eu, Gd, Tb, Dy, Ho, Er, Tm, Yb).

In another aspect of functionalized nanoparticle the functionalized nanoparticle range in size from about 5 to about 150 nm in diameter.

In another aspect of functionalized nanoparticle the functionalized nanoparticles range in size from about 5 to about 100 nm in diameter.

### FIGURES

Scheme 1. Schematic illustration of preparation and bio-conjugation of silica-coated LaF₃:Ln³⁺ nanoparticles.

FIG. 1. TEM image of as-prepared silica-coated LaF₃:Nd nanoparticles.

FIG. 2. Emission spectra of as-prepared silica-coated a) LaF₃:Eu nanoparticles (λₑₓ=464 nm), b) LaF₃:Tb nanoparticles (λₑₓ=485 nm).

FIG. 3. Decay curve for silica-coated LaF₃:Eu nanoparticles before surface modification. (λₑₓ=464 nm, λₑₘ=591 nm, excitation source—OPO).

FIG. 4. Decay curve for silica-coated LaF₃:Tb nanoparticles before surface modification (λₑₓ=485 nm, λₑₘ=542 nm, excitation source—OPO).

FIG. 5. TEM image of as 800° C. heated silica-coated LaF₃:Nd nanoparticles before surface modification.

FIG. 6. Emission spectra of 800° C. heated silica-coated a) LaF₃:Nd nanoparticles (λₑₓ=514 nm), b) LaF₃:Yb,Er nanoparticle (λₑₓ=980 nm).

FIG. 7. Decay curve for 800° C. heated silica-coated LaF₃:Nd nanoparticles before surface modification. (λₑₓ=514 nm, λₑₘ=1070 nm, excitation source—OPO).

FIG. 8. Decay curve for 800° C. heated silica-coated LaF₃:Yb,Er nanoparticles before surface modification. (λₑₓ=488 nm, λₑₘ=1540 nm, excitation source—OPO).

FIG. 9. Up-conversion emission spectra 800° C. heated silica-coated a) LaF₃:Yb,Er nanoparticles (λₑₓ=980 nm), b) LaF₃:Yb,Tm nanoparticles (λₑₓ=980 nm).

FIG. 10. Up-converted blue emission spectrum of 800° C. heated silica-coated LaF₃:Yb,Tm nanoparticles before surface modification (λₑₓ=980 nm, excitation source −980 nm CW laser).

FIG. 11. Emission spectra of silica-coated LaF₃:Tb nanoparticle after bioconjugation with FITC-avidin beads a) specific binding, b) non-specific binding (λₑₓ=485 nm).

FIG. 12. The emission spectra of FITC-avidin bound silica-coated LaF₃:Tb nanoparticles in 10 mM phosphate-buffered saline solution. (λₑₓ=485 nm, excitation source—OPO). Inset shows the decay curve of Tb³⁺ ion (λₑₓ=485 nm, λₑₘ=542 nm, excitation source—OPO). The effective lifetime was calculated by neglecting the initial part of the decay curve (0-0.8 ms), which is from FITC.

FIG. 13. Emission spectra of silica-coated LaF₃:Nd nanoparticle after bioconjugation with FITC-avidin beads in 10 mM phosphate-buffered saline solution a) specific binding, b) non-specific binding (λₑₓ=485 nm, excitation source—Xe lamp).

FIG. 14. The emission spectra of FITC-avidin bound silica-coated LaF₃:Nd nanoparticles in 10 mM phosphate-buffered saline solution. (λₑₓ=514 nm, excitation source—OPO). Inset shows the decay curve of Nd³⁺ ion (λₑₓ=514 nm, λₑₘ=1070 nm, excitation source—OPO).

FIG. 15. A schematic diagram of the synthesis of the silica-coated, core-shell (LaF₃:Tm)LaF₃ nanoparticles. Core and shell thicknesses are not to scale.

FIG. 16. A prior art schematic diagram of the relevant Tm³⁺ levels and transitions.

FIG. 17. Emission spectrum of citrate-stabilized (LaF₃:Tm(2%))LaF₃ in D₂O. λₑₓ 785 nm. Inset shows the luminescent decay curve of citrate-stabilized (LaF₃:Tm(2%))LaF₃ in D₂O. λₑₓ 785 nm, λₑₘ 1450 nm.

FIG. 18. Emission spectrum of silica-coated (LaF₃:Tm(2%))LaF₃ as a KBr pellet. λₑₓ 785 nm.

FIG. 19. A. Overlaid emission spectra of silica-coated (LaF₃:Tm(2%))LaF₃ at (a) 294 K and (b) 77 K. λₑₓ 785 nm. Deconvolution of the ³H₄-³F₄ transition measured at 77 K fitted with six Gaussian peaks. B. The overlaid lifetime analysis of silica-coated (LaF₃:Tm(2%))LaF₃ at (a) 294 K and (b) 77 K. λₑₓ 785 nm, λₑₘ 1450 nm.

FIG. 20. Emission spectrum of the ³H₄-³H₆ transition at 1.85 μm. λₑₓ 785 nm.

### DETAILED DESCRIPTION

Herein, we report a general and easy method for the preparation and bioconjugation of silica-coated LaF₃:Ln³⁺ nanoparticles that display several non-overlapping emission lines that cover the visible to near-infrared region (450-1900 nm) through down-conversion as well as up-conversion processes, which can for instance be exploited in multiplexing applications.^{[xx]} LaF₃ material has second lowest phonon energy of the commonly used Ln³⁺-doping matrices (Table 1^{[xix,xxi,xxii]}) thus minimizing the quenching of the excited state lanthanide ions from lattice vibrations. Also the La³⁺ ions are easily substituted within the LaF₃ matrix upon doping, without the problems associated with either a significant lattice mismatch of two different ions or lanthanide ion clustering.

TABLE 1
Table of selected lattice phonon energies of
commonly used matrices for Ln³⁺ doping.

| | Highest Phonon |
|---|---|
| Material | energy (cm⁻¹) |
| Phosphate glass | 1200 |
| Silica glass | 1100 |
| Fluoride glass | 550 |
| Chalcogenide glass | 400 |
| LaPO₄ | 1050 |
| YAG | 860 |
| YVO₄ | 600 |
| LaF₃ | 300 |
| LaCl₃ | 240 |

### DEFINITIONS

Nanoparticles: The term “nanoparticles” as used herein, can also refer to nanoclusters, clusters, particles, dots, quantum dots, small particles, and nanostructured materials.
When the term “nanoparticle” is used, one of ordinary skill in the art will appreciate that this term encompasses all materials with small size and often associated with quantum size effects, generally the size is less than 100 nm. Nanoparticles can comprise a core or a core and a shell, as in core-shell nanoparticles.
All nanoparticles may have one or more Ln independently selected from the list below and comprise at least one of:

### LnX₃ (X=F, Cl, Br, I)

### LnOX (X=F, Cl, Br, I)

### Ln₂X₃ (X=O, S, Se, Te)

### Ln₂XxYy (X=O, S, Se, Te; Y=O, S, Se, Te)

### Ln₂X₃ (X=CO₃, C₂O₄, SO₄, SO₃)

### LnX (X=PO₄, PO₃, VO₄)

### Borates

### Aluminates

### Gallates

### Silicates

### Germanates

### Niobates

### Tantalates

### Wolframates

### Molybdates

### Nitrides

### XO₂ (X=Ti, Zr, Hf, Ge, Sn, Pb)

### XO (X=Ge, Sn, Zn, Pb, Cd, Hg)

### X₂O₅ (X=V, Nb, Ta)

### X₂O₃ (X=Al, Ga, In)

Precursor nanoparticle: A nanoparticle that is used for making a product nanoparticle. The resulting product nanoparticle may or may not be comprised of the precursor nanoparticle.
Product nanoparticle: A nanoparticle prepared from a precursor nanoparticle and a coating comprising one or more of silica, alumina, zirconia, titania, hafnia, tantalum pentoxide, niobium pentoxide, germanium dioxide, yttrium oxide (Y₂O₃), and gadolinium oxide (Gd₂O₃). The product nanoparticle may or may not comprise precursor nanoparticle. The product nanoparticle can be a core-shell nanoparticle or it may only comprise the core.
Lanthanides: The term “lanthanide” as used herein refers to Ce, Pr, Nd, Sm, Eu, Gd, Tb, Dy, Ho, Er, Tm, Yb, La, Lu, Y, Sc combinations thereof, compounds containing Ce, Pr, Nd, Sm, Eu, Gd, Tb, Dy, Ho, Er, Tm, Yb, La, Lu, Y, Sc and combinations thereof, and ions of Ce, Pr, Nd, Sm, Eu, Gd, Tb, Dy, Ho, Er, Tm, Yb, La, Lu, Y, Sc and combinations thereof. Ionic states ranging from +2 to +4 are contemplated.
Presenting substrate: Any material that can interact with the silica coating by adhesion, or chemical bonding, including hydrophobic interactions, hydrogen bonding, ionic bonding and covalent bonding, for example, but not to be limiting. Presenting materials include, for example, but not limited to avidin, streptavidin, biotin, antibody, polynucleotide, lectin, protein A, polypeptides and any ligands. These can in turn can interact with, for example, but not limited to drugs, antigens, toxins antibodies, streptavidin, protein A, polypeptides, and polynucleotides.
Functionalized nanoparticle: Any combination of a product nanoparticle and a presenting material.
Reporters: fluoresceins, cyanines, xanthenes, rhodamines, acridines and oxazines.
Ligands: All ligands may have one or more functional group independently selected from the following:
Carboxylic acids and their esters;
Organo phosphorous compounds (phosphonic and phosphinic acids and their esters), phosphonates, phosphine oxides;

### Alcohols;

### Thiols;

### Sulfoxides;

### Sulfones;

### Ketones;

### Aldehydes;

Polymers of the above listed ligands; and
Alkyl ammonium compounds (RNH³⁺, R₁R₂NH₂⁺, R₁R₂R₃NH⁺, R₁R₂R₃R₄N⁺, with Rx=alkyl or aromatic substituent).

### EXAMPLES

Chemicals of the highest purity were obtained from Aldrich and used without further purification. The FITC-avidin was obtained from Invitrogen and used as received. All water used was distilled. All nanoparticles were made with LaF₃ at were doped at the respective % atom doping on the total Ln³⁺ amount.

### Synthesis of Nanoparticles

The synthesis is based on our earlier reported procedure to prepare the citrate-stabilized core-shell (LaF₃:Tm³⁺)LaF₃ nanoparticles^{[ix,xxiii]}. Around 2 g of citric acid was dissolved in 35 mL of water and the pH adjusted to 5 by adding NH₄OH, then followed by the addition of NaF (0.1 g, 1.33 mmol). The solution was heated to 75° C. followed by the addition of La(NO₃)₃.6H₂O (0.54 g, 1.26 mmol) and Tm(NO₃)₃.5H₂O (0.02 g, 0.05 mmol) dissolved in 2 ml of methanol. After 10 min, the shell was formed by the addition of 10 drops at a time of La(NO₃)₃.6H₂O (0.6 g, 1.33 mmol) in 2 mL of methanol, and NaF (0.1 g, 1.33 mmol) in 2 ml of water, in sequential order. The reaction was allowed to continue for 2 h and finally the nanoparticles were precipitated by the addition of excess of ethanol to the reaction mixture. They were collected by centrifuge and dried for 24 h.

### Synthesis of Silica-Coated LaF₃:Ln³⁺ Nanoparticle

50 mg of citrate stabilized LaF₃:Ln³⁺ nanoparticles dissolved in 1.44 mL of distilled water was added to ethanol (20 mL) and 30% NH₄OH (0.4 mL) mixture. 1.2 mL of tetraethyl orthosilicate (TEOS) was added to the above mixture. The mixture was stirred for 60 min. White coloured silica beads were centrifuged and washed with ethanol for several times. Silica beads were dried under vacuum. Silica-coated LaF₃:Nd, LaF₃:Yb,Er, and LaF₃:Yb,Tm nanoparticles were heated at 800° C. for 12 hr in air.

Surface Modification of the Silica-Coated LaF₃:Ln³⁺ Nanoparticles with 3-aminopropyltrimethoxysilanes (APTMS)

10 mg of silica-coated LaF₃:Ln³⁺ nanoparticles were suspended in 10 ml of ethanol, followed by the addition of 0.5 ml (2 mmol) of APTMS and stirred for 24 hr at room temperature. The particles were isolated and purified by centrifugation, washed 3 times with ethanol and dried under reduced pressure.

### Biotinylation of Silica-coated LaF₃:Ln³⁺ Nanoparticles

10 mg of APTMS modified silica-coated LaF₃:Ln³⁺ nanoparticles were suspended in 2 ml of DMSO, followed by the addition of 10 mg (0.03 mmol) of (+)-biotin N-hydroxysuccinimide ester and stirred for 1.5 hr at room temperature. The particles were isolated and washed by centrifugation, washed once with water and three times with ethanol, and dried under reduced pressure.

Biotin-FITC-avidin binding: 10 mg of amine-modified silica-coated LaF₃:Ln³⁺ nanoparticles were suspended in 10 ml of 10 mM phosphate-buffered saline, pH 7.4, followed by the addition of 0.4 ml of FITC-avidin (final avidin concentration of 0.1 mg/ml) and stirred for 2.5 hr at room temperature. The particles were isolated and purified by centrifugation, washed 5 times with 10 mM phosphate-buffered saline solution and resuspended in 10 ml of 10 mM phosphate-buffered saline solution.

### Characterization of Silica-Coated LaF₃:Ln³⁺ Nanoparticle

### Luminescence Studies

Down-conversion luminescence analyses were done using an Edinburgh Instruments FLS 920 fluorescence system, which was equipped a CW 450W xenon arc lamp via an M300 single grating monochromator and a 10 Hz Q-Switched Quantel Brilliant, pumped by a Nd:YAG laser, attached with an optical parametric oscillator (OPO) with an optical range from 410 to 2400 nm. The excitation source used for up-conversion was a Coherent 2-pin 980 nm CW semiconductor diode laser with Pₘₐₓ=800 mW at 1000 mA. The fiber is coupled to 100 μm (core) fiber. A red-sensitive Peltier-cooled Hamamatsu R955 photomultiplier tube (PMT), with a photon-counting interface, was used for analyses between 200 and 850 nm, and a N₂-cooled (−80° C.) Hamamatsu R5509PMT was used for analyses between 800 and 1700 nm. All emission analyses in the visible region were measured with a 1 nm resolution. All emission analyses in the near-infrared region were measured with a 10 nm resolution. All spectra were corrected for detector sensitivity. Lifetime analyses for all nanoparticles were done by exciting the solution with a 10 Hz Q-Switched Quantel Brilliant, pumped by a Nd:YAG laser, with an optical range from 410 to 2400 nm, and collecting the emission using the respective detector mentioned above. Decay curves were measured with a 0.01 ms lamp trigger delay for the R955PMT. Effective lifetimes were calculated using origin 7 software. The effective lifetimes were calculated using origin 7 software based on the equation [1],

$${τ}_{eff} = \frac{{\int }_{0}^{∞} t / ( t ) d t}{{\int }_{0}^{∞} / ( t ) d t}$$

All luminescence studies were carried out as dry powders for unmodified 800° C. heated silica-coated LaF₃:Nd, LaF₃:Er, LaF₃:Yb, Er and LaF₃:Yb, Tm nanoparticles. Other samples were carried as buffer solutions.

### Transmission Electron Microscope (TEM)

TEM of the silica-coated LaF₃:Ln³⁺ nanoparticles was carried out using a Hitachi H-7000 microscope, operated at 100 kV. Around 1-2 mg of sample was dispersed in 5 mL of ethanol and a drop of this mixture was evaporated on a carbon-coated 300 mesh copper grids. Around 45 images were recorded from different region of the same sample and an average particle size was obtained based on a minimum of 100 particles.

### Results

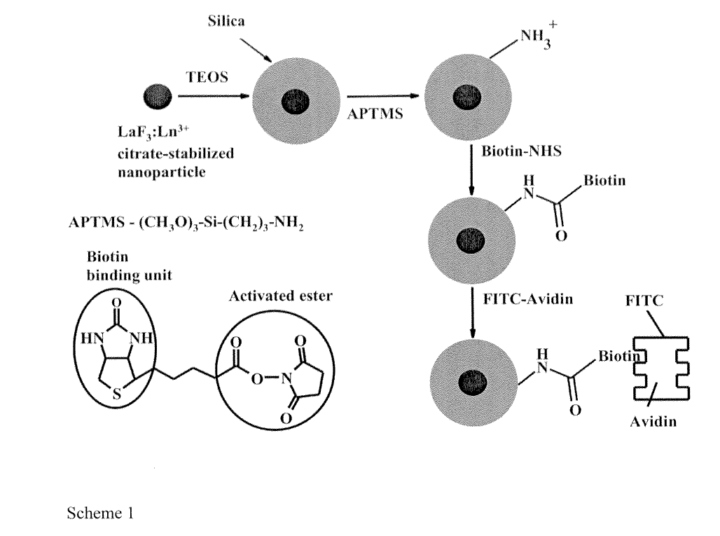

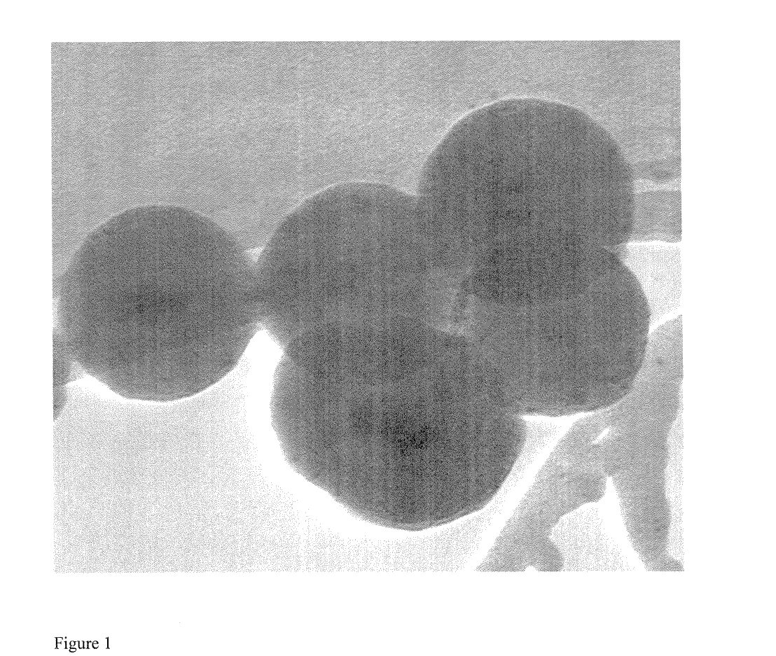

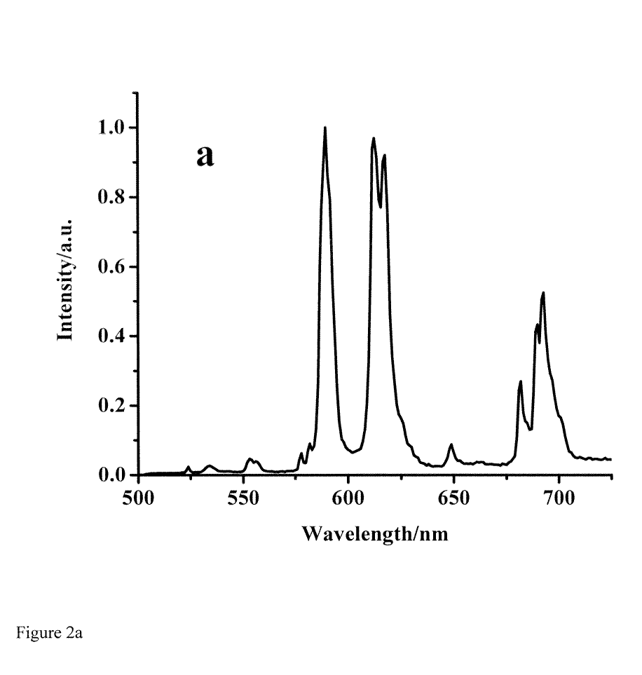

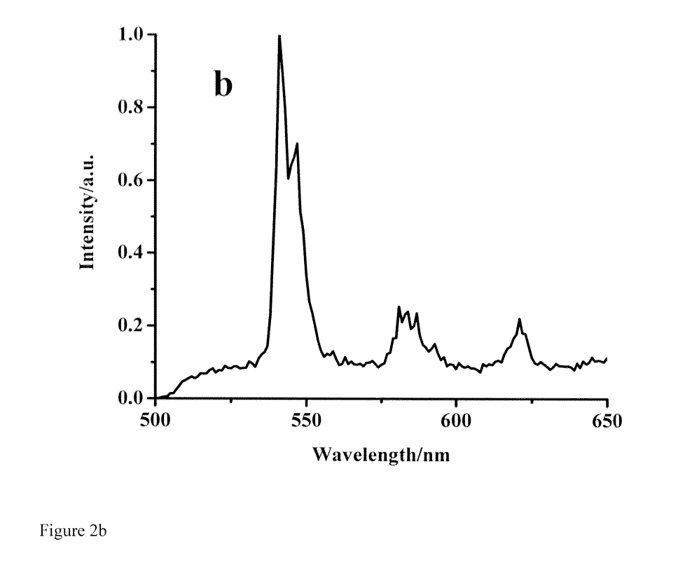

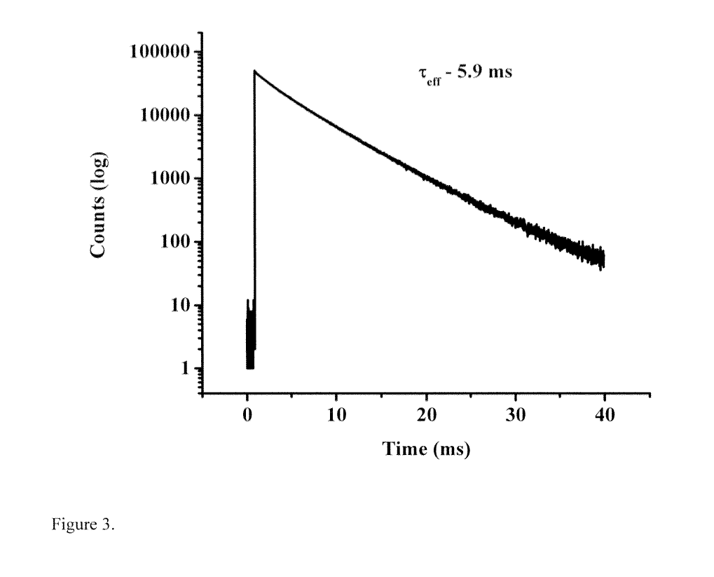

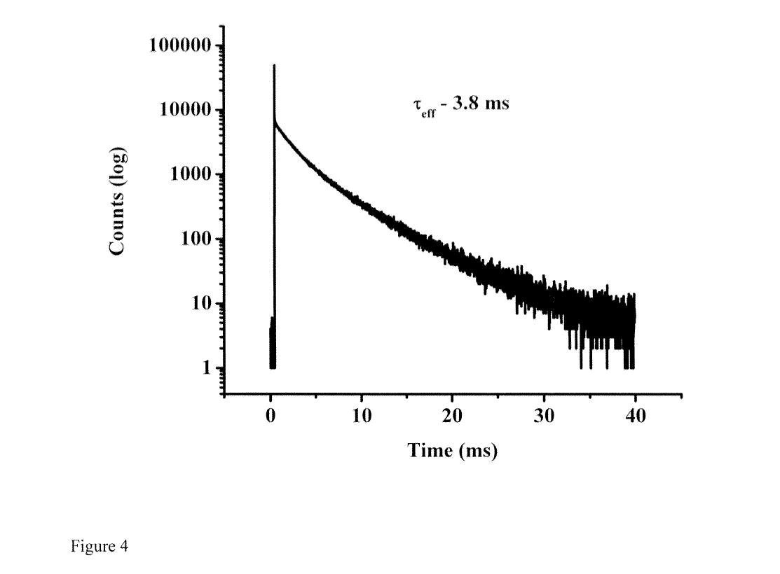

The transmission electron microscopy (TEM) image shown in FIG. 1 is of the as-prepared silica-coated LaF₃:Nd nanoparticles, which clearly shows that almost all the silica beads have a single core LaF₃:Nd nanoparticle (˜5 nm) in the center with an average shell thickness of ˜17 nm. The LaF₃:Nd core has a slightly higher contrast than the SiO₂ shell. FIG. 2a shows the emission spectrum of the as-prepared silica-coated LaF₃:Eu nanoparticles, in which the major emission bands of the Eu³⁺ ions at 590 nm and 612 nm are assigned to the ⁵D₀ to ⁷F₁ and ⁵D₀ to ⁷F₂ transitions, and an effective lifetime of 5.9 ms is assigned to the ⁵D₀ level (FIG. 3). Additionally, the emission spectrum of the as-prepared silica-coated LaF₃:Tb³⁺ nanoparticles is shown in FIG. 2b, in which the most intense peak at 545 nm corresponds to ⁵D₄ to ⁷F₅ transition, and the peaks at 586 and 623 nm correspond to the ⁵D₄ to ⁷F₄ and ⁷F₃ transitions, respectively. An effective lifetime of 3.7 ms is attributed to the ⁵D₄ level (FIG. 4).

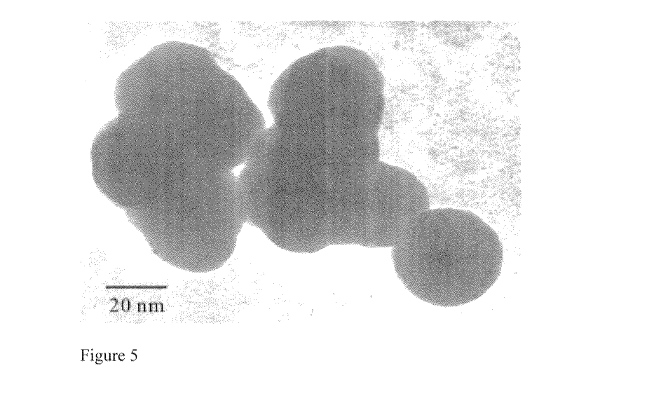

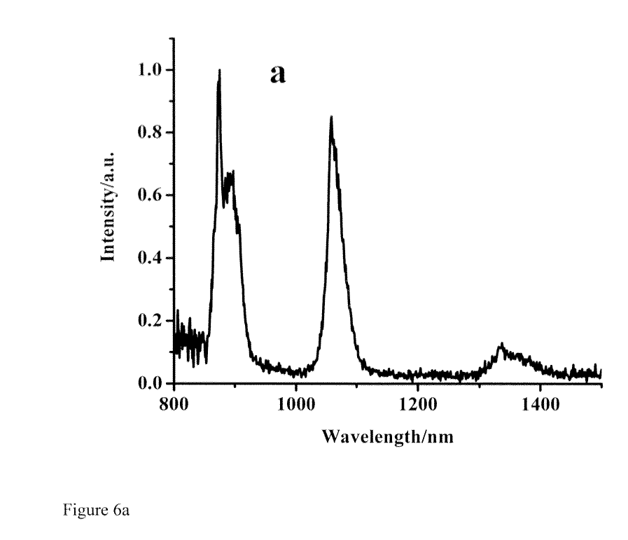

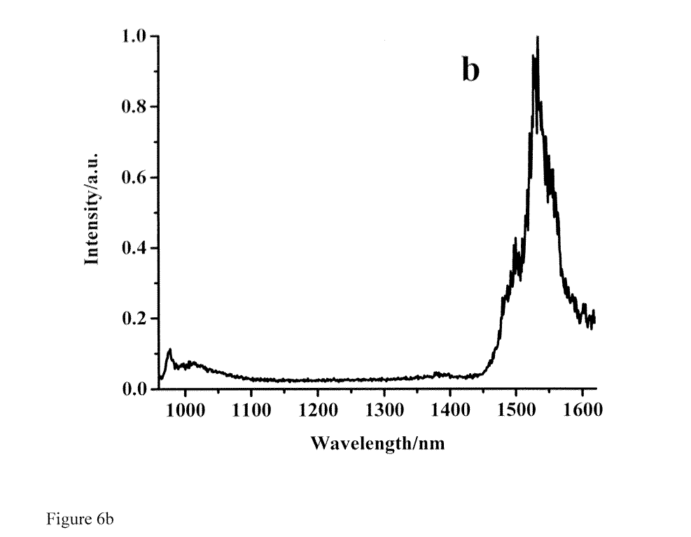

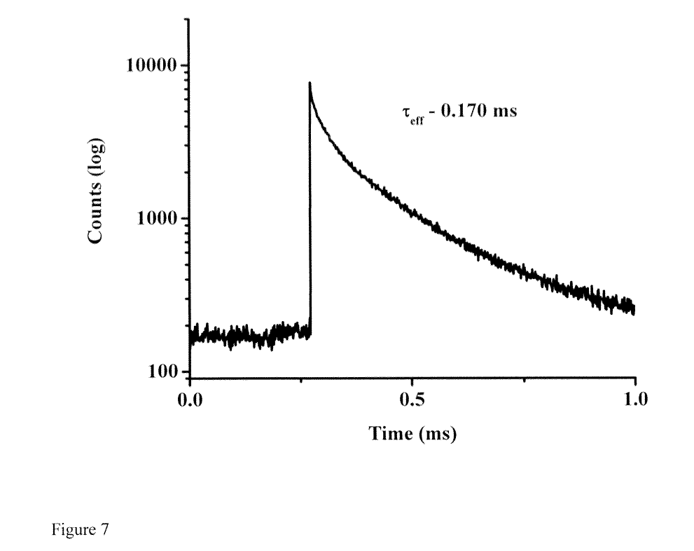

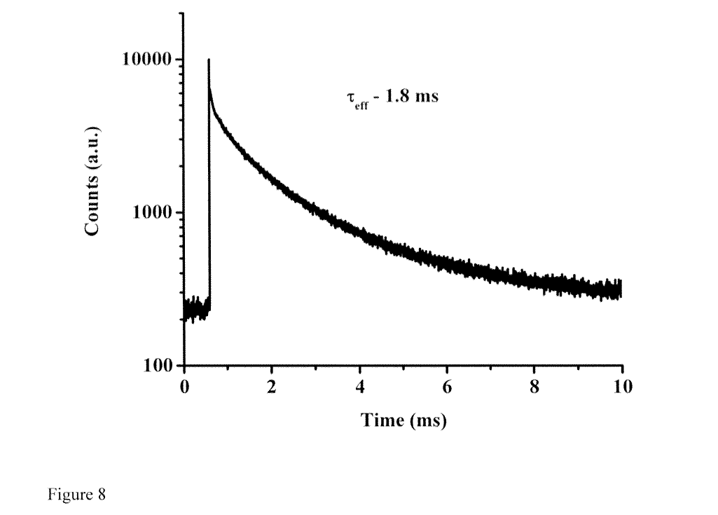

FIG. 5 shows the TEM image of silica-coated LaF₃:Nd nanoparticle heated at 800° C. for 12 hr, resulting the beads to contract to an average shell thickness of ˜15 nm. FIG. 6a shows the emission spectrum of the silica-coated LaF₃:Nd nanoparticles, where the emission peaks at 870 nm, 1070 nm, and 1330 nm are from ⁴F_{3/2} transitions to ⁴I_{13/2}, ⁴I_{11/2}, and ⁴I_{9/2}, respectively, with a effective luminescent lifetime of 170 μs (FIG. 7). Due to the ability of lanthanide ions to be excited indirectly through the sensitized emission of another lanthanide ion, FIG. 6b shows the emission spectrum of silica-coated LaF₃:Yb,Er nanoparticles, via sensitized emission from Yb³⁺ to the Er³⁺ ions, by direct excitation of the Yb³⁺ ions at 940 nm. The importance of this spectrum demonstrates that though Er³⁺ has no absorption lines at this wavelength, this process results in the simultaneous very weak emission of Yb³⁺ at 980 nm (attributed to the ²F_{5/2} to ²F_{7/2} transition), and the shown sensitized emission of the Er³⁺ ions at 1540 nm (⁴I_{13/2} to ⁴I_{15/2} transition), with an effective lifetime of 1.8 ms from the ⁴I_{13/2} level (FIG. 8).

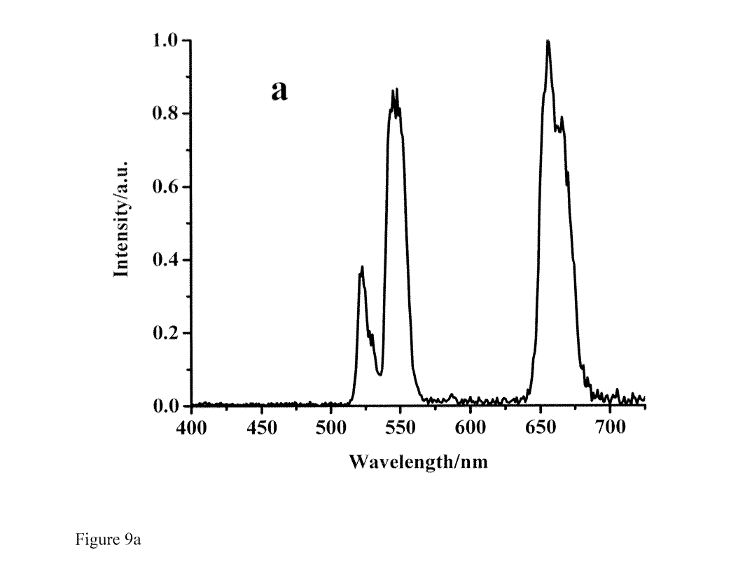

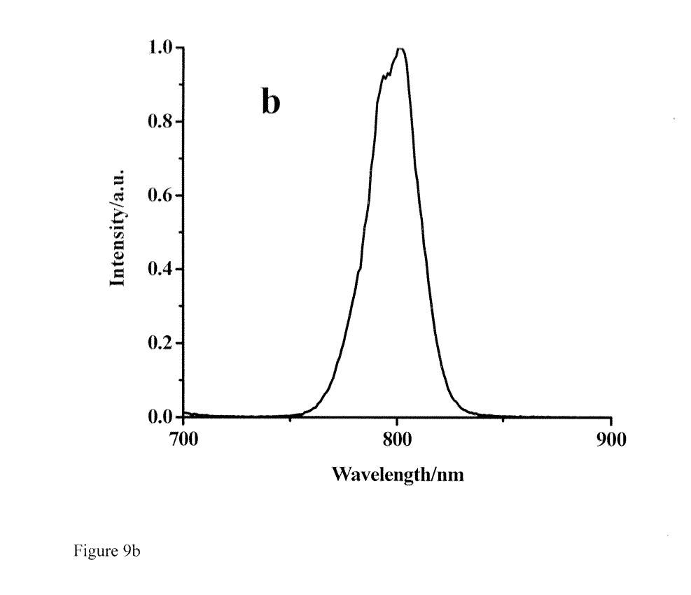

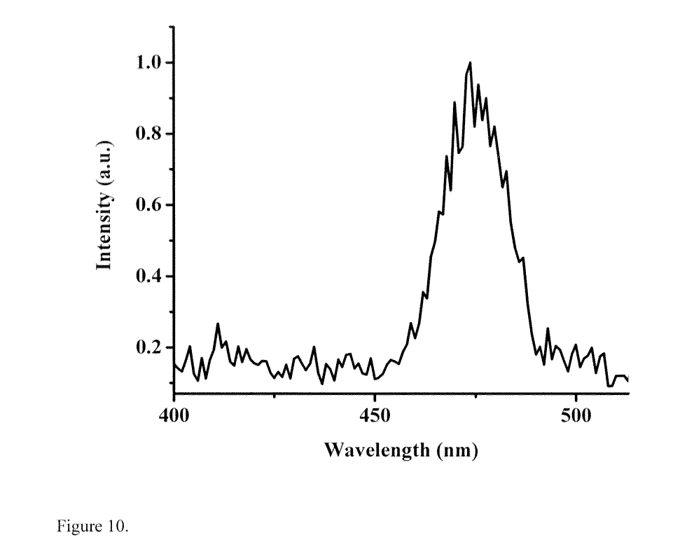

The up-conversion emission spectrum of the 800° C. heated silica-coated LaF₃:Yb,Er nanoparticles, FIG. 9a shows the emission spectrum of the Er³⁺ ions by up-conversion, with the peaks at 515, 540 nm, and 660 nm being assigned to the ²H_{11/2} to ⁴I_{15/2}, ⁴S_{3/2} to ⁴I_{15/2}, and ⁴F_{9/2} to ⁴I_{15/2} transitions, respectively. Furthermore, FIG. 9b demonstrates the up-conversion emission spectrum of heated silica-coated LaF₃:Yb,Tm nanoparticles, in which the emission band around 800 nm is a result of the ³H₄ to ³H₆ transition of Tm³⁺ ions. Moreover, a weak Tm³⁺ emission band at 475 nm was observed and assigned to the ¹G₄ to ³H₆ transition (FIG. 10), and is also a result of the up-conversion process. Preliminary results into the mechanism of the up-conversion process involving Tm³⁺ suggest that it is occurring via energy transfer (ET) rather than an excited state absorption (ESA) or photoavalanche (PA) process.^{[ix]} Some evidence has been gathered that the up-conversion involving Er³⁺ likely proceeds via a photo-avalanche mechanism, if certain conditions are met.

To test the ability for the core-shell silica nanoparticles to be bound to a biological system, surface modification of the silica shell with biotin was used as a model for nanoparticle binding with FITC-avidin, and the extent of binding monitored by the FITC emission intensity. Due to the biologically inert nature of silica, the shell had to be modified first in a two-step process in order to impart biotin activity, as shown in Scheme 1.

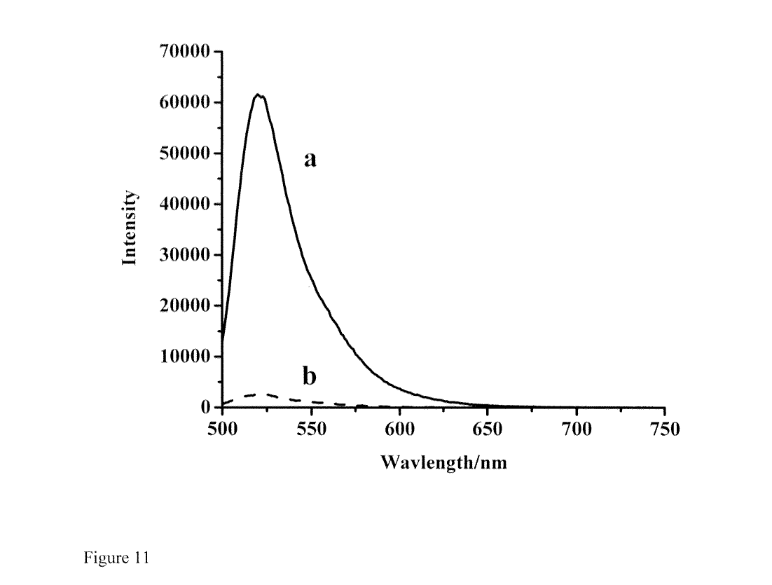

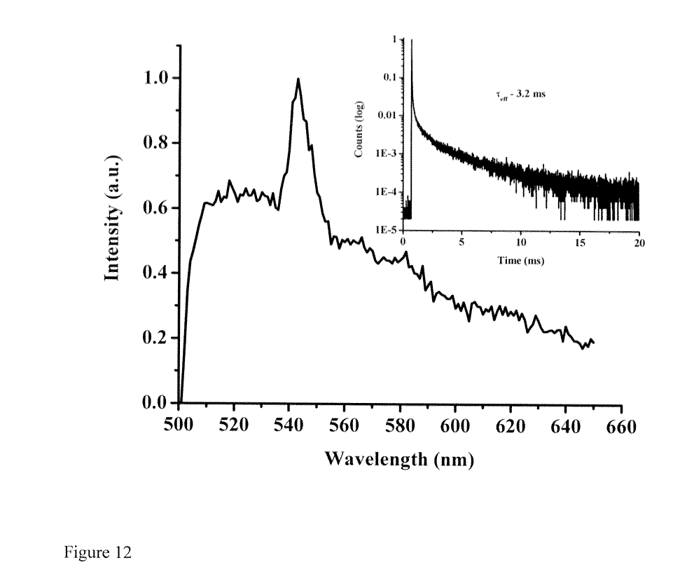

The emission spectra of bioconjugation of silica-coated LaF₃:Tb nanoparticles to FITC-avidin, which is overlaid along with non-biotinylated particles as control particles, is shown in the FIG. 11. The emission spectra show an approximate 25-fold increase in FITC signal over the control particles, clearly proving that specific binding of avidin to the silica particles has been achieved, and that the signal from the control particles is likely a result of some physical adsorption of avidin onto the particles in a negligible amount. Our previous work has shown that coating the surface of LaF₃:Ln³⁺ nanoparticles with poly(ethylene glycol)-based ligands minimized the effects of non-specific binding, and we expect the same result with our current silica-coated particles.^{[10]} FIG. 12 shows the Tb³⁺ emission spectrum of the particles excited with high excitation power, in which the dominant 544 nm peak of Tb³⁺ is visible on top of the FITC signal with an effective luminescent lifetime of 3.2 ms (inset in FIG. 12), which is in agreement with that of the unmodified and APTMS modified particles. The reason for the low Tb³⁺ signal is due to the fact that lanthanide ions have a very low absorption coefficient when compared to FITC and with an excitation wavelength of 485 nm that excites both the FITC and the Tb³⁺ ions, the emission spectrum of the FITC will dominate.

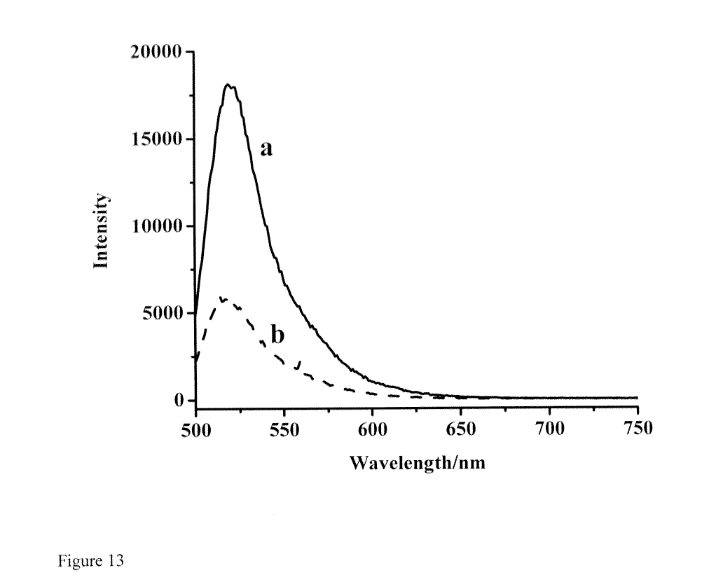

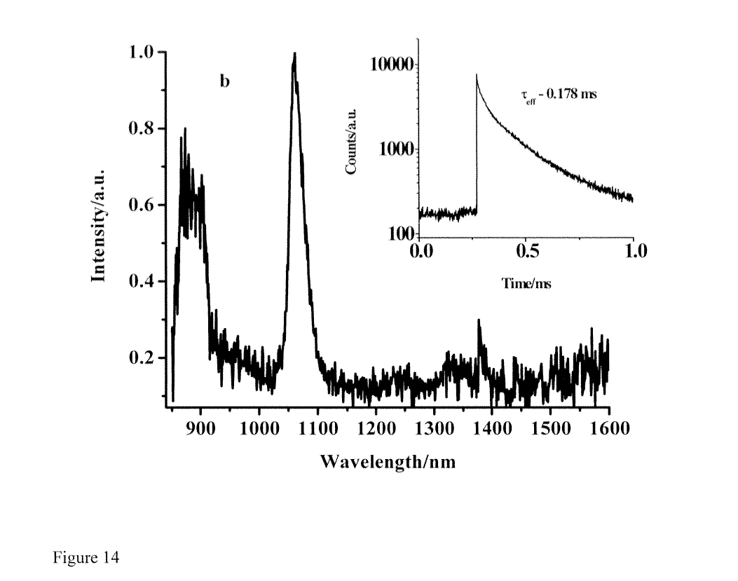

The same binding experiments were carried on silica-coated LaF₃:Nd nanoparticles resulting in a similar increase in FITC emission over the control particles (FIG. 13). FIG. 14 shows the emission spectrum of the silica-coated LaF₃:Nd nanoparticles, showing the characteristic peaks at 870 nm, 1064 nm and 1330 nm, with an effective luminescent lifetimes of 178 μs (inset in FIG. 14), which is in agreement with that of the unmodified particles. The formation of the silica coating over the LaF₃:Nd and LaF₃:Yb,Er nanoparticles improved the NIR luminescence significantly by minimizing the solvent quenching effect as compared to our previously reported citrate and 2-aminoethylphosphate stabilized LaF₃:Nd nanoparticles.^{[10]}

The preparation of the (LaF₃:Tm)LaF₃ citrate-stabilized nanoparticles followed established procedures resulting in an average particle diameter of 7-10 nm.^{[ix,xxiii,xxiv]}

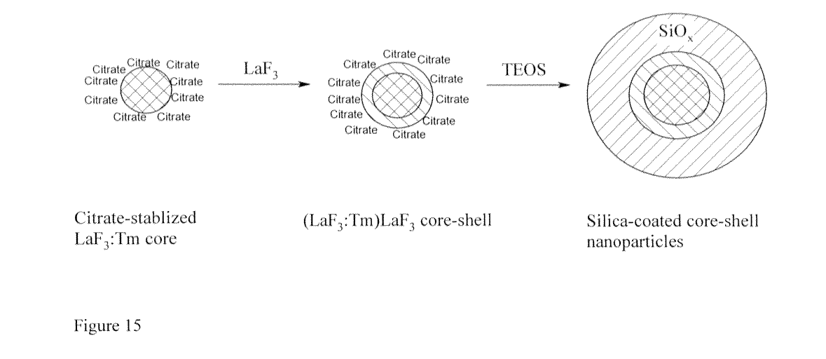

Synthesis of the nanoparticles is outlined in FIG. 15, which starts from citrate-stabilized LaF₃:Ln³⁺ precursor nanoparticles as the core matrix, followed by the formation of a LaF₃ shell, which is then coated with a silica shell via a modified Stöber process.^{[xxv]} The resulting particles are fairly monodisperse with an average diameter of 40±5 nm (TEM). Energy dispersive X-ray (EDX) analysis of the core-shell particles confirmed the presence of the Tm³⁺ at 1% relative to La³⁺, meaning the core itself is doped at 2%, and gave a F to Ln ratio of ca. 2.8:1 confirming that the surface is stabilized with citrate ions.

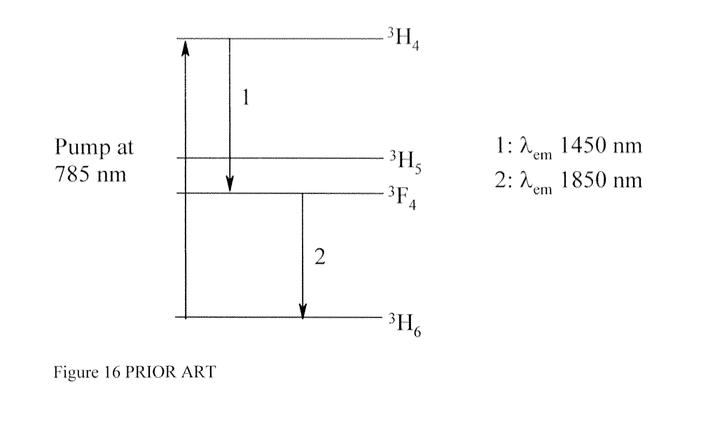

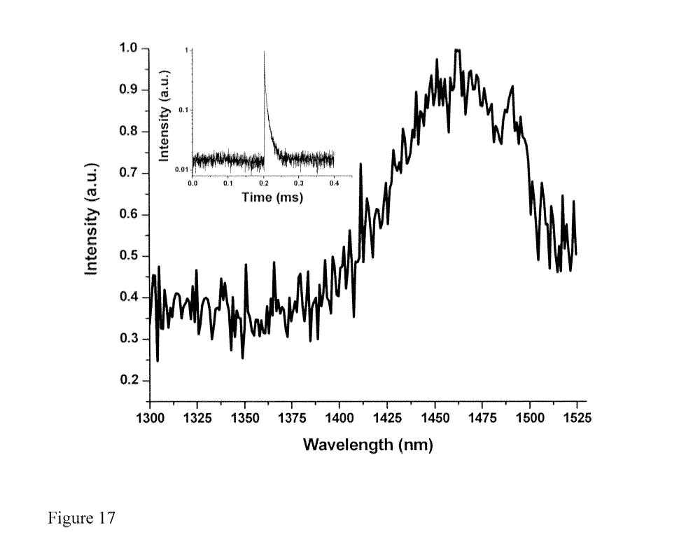

FIG. 16 shows a schematic diagram of the excitation and emission levels of interest from Tm³⁺, where excitation of the nanoparticles into the ³H₄ level at 785 nm result in two emission bands at 1470 nm (³H₄-³F₄ transition) and 1870 nm (³F₄-³H₆ transition). The emission and luminescent lifetime spectra of the particles, in D₂O, are shown in FIG. 17. The peak intensity of the emission band in FIG. 17 is centered at ca. 1470 nm and is assigned to the ³H₄-³F₄ transition. The inset in FIG. 17 shows the decay curve of the particles with an effective lifetime of 9 μs. In comparison to a radiative lifetime of 1513 μs for Tm³⁺-doped LiYF₄ nanoparticles by Walsh et al.^{[xxvi]}, the short luminescent lifetime of our particles is a result of high level of quenching, and is primarily attributed to the coordination of OD groups from the citrate molecules and D₂O to the nanoparticle surface. Additionally, the short lifetime suggests that the LaF₃ shell does not completely shield the Tm³⁺ ions from quenching effects. An estimation of the quantum yield (Φ) using the formula below

$$Φ = \frac{{τ}_{obs}}{{τ}_{rad}}$$

results in a value less than 1%. Other reports of Tm³⁺-doped systems^{[xxvii,xxviii]} such as glasses, silica fibers and ceramics have radiative lifetimes that are within ±0.2 ms of that referenced above, showing that the radiative lifetime (τ_{rad}) is not very sensitive to the crystal field.

In order to improve the luminescent properties of the nanoparticles, reduction of the non-radiative decay processes was done by the formation of a silica-coating over the particles followed by curing at 900° C. for 24 hours. The curing process was found to improve the luminescent properties for two reasons: first, the high temperature removes most surface bound OH groups, such as water and Si—OH groups, which are known to quench luminescence.^{[ix,xxiii,xxiv]} Moreover, the elevated temperatures convert a large portion of the Si—OH into SiOₓ groups, further minimizing the number of OH groups in contract with the LaF₃ shell. Secondly, the heating process also causes the silica shell to contract in diameter, densifying the shell and making it less porous to solvent, which also reduces quenching effects as reported elsewhere.^{[xxiv]}

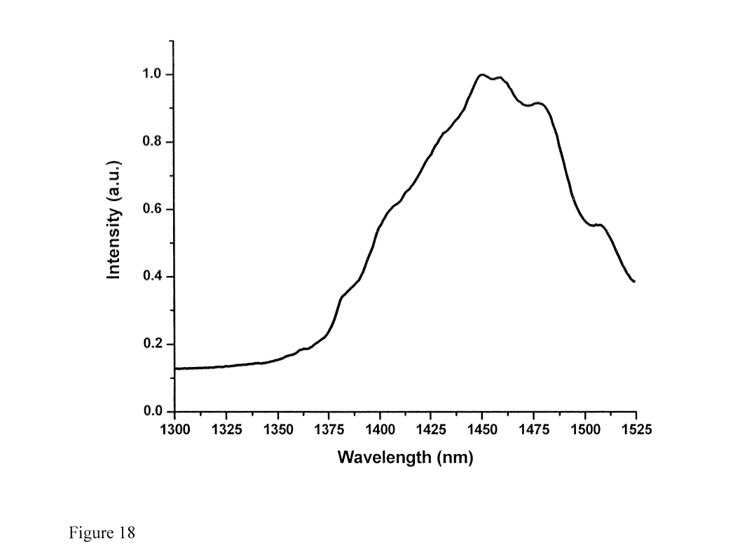

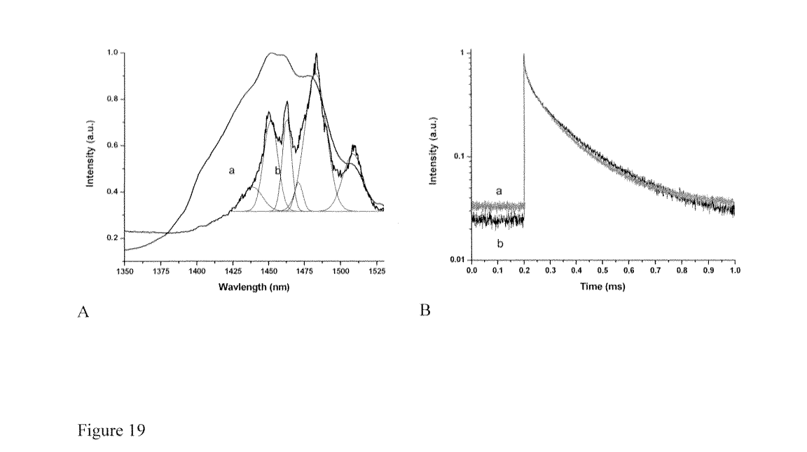

FIG. 18 shows the emission spectrum of the particles at 294 K upon excitation at 785 nm, and exhibits a broad set of overlapping peaks centered around 1450 nm, and is attributed to the ³H₄-³F₄ transition. The broadness of the transition, which has some barely resolved fine structure, is in agreement with other reports^{[xxvi]} and is a result of crystal field splitting of the ³H₄ and ³F₄ levels. To study further the crystal field splitting, the sample was cooled to 77 K and the emission spectrum was measured at a high resolution (2 nm). Shown in FIG. 19A are the overlaid emission spectra of the ³H₄-³F₄ transition at (a) 294 K and (b) 77 K, in which a reduction in the width of the emission band is seen indicating that the ³H₄ levels are thermally populated at room temperature. An estimation of six crystal field levels by Gaussian deconvolution of the overlapped peaks of the 77 K emission was observed, which is similar to studies done by Ryba-Romanowski et al.^{[xxix]} on Tm³⁺-doped SrGdGa₃O₇ single crystals grown by the Czochralski method^{[xxx]}, who also observed six of the nine theoretical crystal field levels for the ³F₄ level. The nine crystal field levels of the ³F₄ level are derived from the formula 2J+1, which is based on the Russell-Saunders assignment of ^{2S+1}Lⱼ, where J is the total angular momentum. The decay curves of the samples at 294 K and at 77 K are shown overlaid in FIG. 19B, with an effective lifetime of 151±10 μs and 188±10 μs, respectively. The difference in the two values suggests that there is a reduction in non-radiative processes for the cooled sample, as its lifetime is slightly longer.

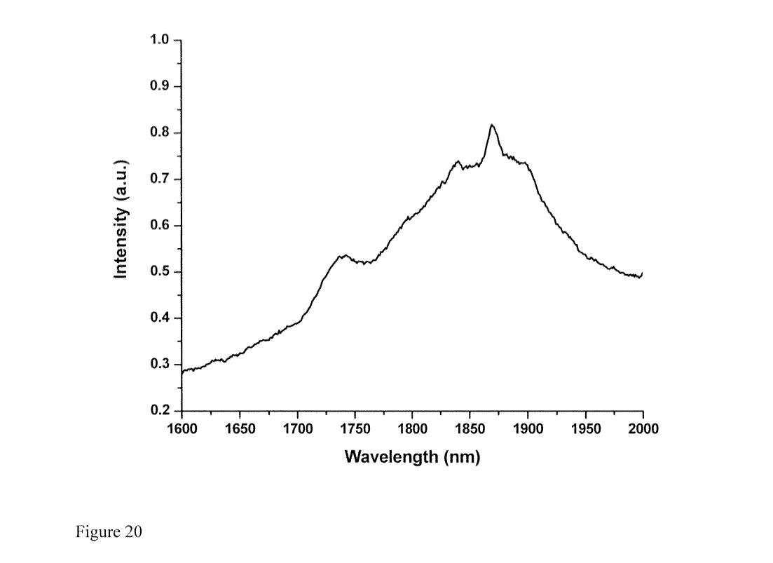

Finally, the low temperature analysis of the nanoparticles in FIG. 20 shows the emission spectrum of the ³F₄-³H₆ transition around 1.85 μm. Luminescent lifetime analysis could not be done due to the low luminescent output at that emission wavelength.

In conclusion, a general and facile method for the production of bioconjugated silica-coated LaF₃:Ln³⁺ nanoparticles with a uniform size distribution has successfully been demonstrated. A wide range of emission lines (450-1650 nm) by up- and down-conversion processes have been achieved by doping with different lanthanide ions. In particular, the excitation with 980 nm light on co-doped silica-coated LaF₃:Yb,Tm nanoparticles resulted in 800 nm emission by up-conversion processes, which is of potential to biological applications. The surface modification of silica-coated nanoparticles with APTMS, followed by biotin for biotin-avidin binding, resulted in a 25-fold increase in the FITC signal over non-biotin functionalized silica-coated nanoparticles. We have also successfully prepared silica-coated, core-shell (LaF₃:Tm)LaF₃ nanoparticles that exhibited 1.47 μm and 1.87 μm emission. Use of the silica shell drastically improved the luminescence of the particles with an estimated quantum yield of 10% for the ³H₄-³F₄ transition, and is the highest reported value for any lanthanum trihalide nanoparticle. Finally, the ³F₄-³H₆ transition at 1.85 μm was measured at 77 K.

The foregoing is a description of embodiments of the technology. As would be known to one skilled in the art, variations would be contemplated that would not alter the scope of the technology. For example, (LaF₃:Tm³⁺)LaF₃ could be synthesized. Also, the technology can be applied, but not limited to lights sources for displays, lasers, photonic crystals and light-emitting diodes.
[1] a) M. J. Bruchez, M. Moronne, P. Gin, S. Weiss, A. P. Alivisatos, Science 1998, 281, 2013; b) W. C. W. Chan, S. Nie, Science 1998, 281, 2016.
[2] a) K. L. Holmes, L. M. Lantz, Methods Cell Biol. 2001, 63, 185; b) P. R. Banks, D. M. Paquette, Bioconjug. Chem. 1995, 6, 447.
[3] a) J. R. Taylor, M. M. Fang, S. Nie, Anal. Chem. 2000, 72, 1979; b) R. C. Bailey, J. M. Nam, C. A. Mirkin, J. T. Hupp, J. Am. Chem. Soc. 2003, 125, 13541; c) E. R. Goldman, E. D. Balighian, H. Mattoussi, M. K. Kuno, J. M. Mauro, P. T. Tran, G. P. Anderson, J. Am. Chem. Soc. 2002, 124, 6378; d) J. K. Jaiswal, H. Mattoussi, J. M. Mauro, S. M. Simon, Nature Biotechnol. 2003, 21, 4751; e) S. J. Rosenthal, I. Tomlinson, E. M. Adkins, S. Schroeter, S. Adams, L. Swafford, J. McBride, Y. Wang, L. J. DeFelice, R. D. Blakely, J. Am. Chem. Soc. 2002, 124, 4586.
[4] a) W. J. Parak, D. Gerion, T. Pellegrino, D. Znachet, C. Micheel, S. C. Williams, R. Boudreau, M. A. LeGros, C. A. Larabell, A. P. Alivisatos, Nanotechnol. 2003, 14, 15; b) J.-M. Nam, S. I. Stoeva, C. A. Mirkin, J. Am. Chem. Soc. 2004, 126, 5932.
[5] F. Wang, W. B. Tan, Y. Zhang, X. Fan, M. Wang, Nanotechnol. 2006, 17, R1.
[6] a) C. L. Nehl, N. K. Grady, G. P. Goodrich, F. Tam, N. J. Halas, J. H. Hafner, Nano Lett. 2004, 4, 2355; b) C. Loo, A. Lowers, N. Halas, J. West, R. Drezek, Nano Lett. 2005, 8, 709.
[7] a) J. W. Stouwdam, F. C. J. M. van Veggel, Nano Lett. 2002, 2, 733; b) Stouwdam, J. W.; van Veggel, F. C. J. M. Langmuir 2004, 20, 11763; c) Sudarsan, V.; van Veggel, F. C. J. M.; Herring, R. A.; Raudsepp, M. J. Mater. Chem. 2005, 15, 1332; c) F. Vetrone, J. C. Boyer, J. A. Capobianco, A. Speghini, A. M. Bettinelli, J. Phys. Chem. 2003, 107, 1107; d) A. Patra, C. S. Friend, R. Kapoor, P. N. Prasad, Appl. Phys. Lett. 2003, 83, 284; e) S. Heer, K. Kompe, H-U. Gudel, M. Haase, Adv. Mater. 2004, 16, 2102.
[8] C. Feldmann, T. Justel, C. R. Ronda, P. J. Schmidt, Adv. Funct. Mater. 2003, 13, 511.
[9] J. C. Wright, Topics in Appl. Phys. 1976, 15, 239.
[10] a) P. R. Diamente, F. C. J. M. van Veggel, J. Fluor. 2005, 4, 543; b) P. R. Diamente, R. D. Burke, F. C. J. M. van Veggel, Langmuir 2006, 22, 1782.
[11] F. Meiser, C. Cortez, F. Caruso, Angew Chem. Int. Ed. 2004, 43, 5954.
[12] L. Wang, R. Yan, Z. Huo, L. Wang, J. Zeng, J. Bao, X. Wang, Q. Peng, Y. Li, Angew. Chem. Int. Ed. 2005, 44, 6054.
[13] E. Beaurepaire, V. Buisette, M.-P. Sauviat, D. Giaume, K. Lahill, A. Mercuri, D. Casanova, A. Huignard, J.-L. Martin, T. Gacoin, J.-P. Boilot, A. Alexandrou, Nano Lett. 2004, 11, 2079.
[14] C. Louis, R. Bazzi, C. A. Marquette, J-L. Bridot, S. Roux, G. Ledoux, B. Mercier, L. Blum, P. Perriat, O. Tillement, Chem. Mater. 2005, 17, 1673.
[15] P. Corstjens, M. Zuiderwijk, A. Brink, S. Li, H. Feindt, R. S. Neidbala, H. Tanke, Clin. Chem. 2001, 47, 1885.
[16] a) H. Ow, D. R. Larson, M. Srivastava B. A. Baird, W. W. Webb, U. Wiesner, Nano Lett. 2005, 5, 113-117; b) L. M. Rossi, L. Shi, F. H. Quina, Z. Rosenzweig, Langmuir, 2005, 21, 4277.
[i] F. X. Zang, Z. R. Hong, W. L. Li, M. T. Li, X. Y. Sun, Appl. Phys. Lett. 2004, 84, 2679.
[ii] H. Chen, F. Babin, M. Leblanc, G. He, G. W. Schinn, J. Lightwave Technol. 2003, 21, 1629.
[iii] Y. H. Tsang, D. J. Coleman, T. A. King, Opt. Commun. 2004, 231, 357.
[iv] R. P. Rao, J. Lumin. 2005, 113, 271.
[v] V. Sudarsan, F. C. J. M. van Veggel, R. A. Herring, M. Raudsepp, J. Mater. Chem. 2005, 15, 1332.
[vi] J. W. Stouwdam, M. Raudsepp, F. C. J. M. van Veggel, Langmuir 2005, 21, 7003.
[vii] J. W. Stouwdam, F. C. J. M. van Veggel, Langmuir 2004, 20, 11763.
[viii] J. W. Stouwdam, G. A. Hebbink, J. Huskens, F. C. J. M. van Veggel, Chem. Mater. 2003, 15, 4604.
[ix] S. Sivakumar, F. C. J. M. van Veggel, M. Raudsepp, J. Am. Chem. Soc. 2005, 127, 12464.
[x] H. Zhang, X. Fu, S. Niu, G. Sun, Q. Xin, Solid State Commun. 2004, 132, 527.
[xi] M. Higuchi, T. Shimizu, J. Takahashi, T. Ogawa, Y. Urata, T. Miura, S. Wada, H. Machida, J. Cryst. Growth 2005, 283, 100.
[xii] K. Kuningas, T. Rantanen, U. Karhunen, T. Lovgren, T. Soukka, Anal. Chem. 2005, 77, 2826.
[xiii] K. Kuningas, T. Rantanen, T. Ukonaho, T. Lovgren, T. Soukka, Anal. Chem. 2005, 77, 7348.
[xiv] K. Kuningas, T. Rantanen, T. Lovgren, T. Soukka, Clin. Chime Acta 2005, 355, S237.
[xv] K. Kuningas, T. Rantanen, T. Lovgren, T. Soukka, Anal. Chime Acta 2005, 543, 130.
[xvi] T. Rantanen, K. Kuningas, T. Lovgren, T. Soukka, Clin. Chime Acta 2005, 355, S230.
[xvii] T. Soukka, K. Kuningas, T. Rantanen, V. Haaslahti, T. Lovgren, J. Fluorescence 2005, 15, 513.
[xviii] H. Lai, B. Chen, W. Xu, X. Wang, Y. Yang, Q. Meng, J. Alloys Compd. 2005, 395, 181.
[xix] K. Soga, W. Wang, R. E. Riman, J. B. Brown, K. R. Mikeska, J. Appl. Phys. 2003, 93, 2946.
[xx] D. Gerion, W. J. Parak, S. C. Williams, D. Zanchet, C. M. Micheel, A. P. Alivisatos, J. Am. Chem. Soc. 2002, 124, 7070.
[xxi] D. W. Hewak, R. S. Deol, J. Wang, G. Wylangowski, J. A. Mederios Neto, B. N. Samson, R. I. Laming, W. S. Brocklesby, D. N. Payne, A. Jha, M. Poulain, S. Otero, S. Surinach, M. D. Baro, Electronics Letters 1993, 29, 237.
[xxii] E. R. Taylor, L. N. Ng, N. P. Sessions, H. Buerger, J. Appl. Phys. 2002, 92, 112.
[xxiii] V. Sudarsan, S. Sivakumar, F. C. J. M. van Veggel, M. Raudsepp, Chem. Mater. 2005, 17, 4736.
[xxiv] S. Sivakumar, P. R. Diamente, F. C. J. M. van Veggel, Chem. Eur. J. 2006, in press.
[xxv] W. Stöber, A. Fink, E. J. Bohn, J. Colloid Interface Sci. 1968, 26, 62.
[xxvi] B. M. Walsh, N. P. Barnes, B. Di Bartolo, J. Appl. Phys. 1998, 83, 2772.
[xxvii] M. M. Kozak, D. Goebel, R. Caspary, W. Kowalsky, J. Non-Cryst. Solids 2005, 351, 2009.
[xxviii] R. Balda, L. M. Lacha, J. Fernandez, J. M. Fernandez-Navarro, Opt. Mater. 2005, 27, 1771.
[xxix] W. Ryba-Romanowski, S. GoLvab, I. Sokólska, G. Dominiak-Dzik, J. Zawadzka, M. Berkowski, J. Fink-Finowicki, M. Baba, Appl. Phys. B 1999, 68, 199.
[xxx] W. Piekarczyk, M. Berkowski, G. Jasiolek, J. Cryst. Growth 1985, 71, 395.

1. A lanthanide rich product nanoparticle, said product nanoparticle comprising:
a lanthanide rich precursor nanoparticle synthesized from a mixture comprising lanthanide ions; and
a coating comprising one or more of silica, alumina, zirconia, titania, hafnia, tantalum pentoxide, niobium pentoxide, germanium dioxide, Ln₂O₃ (Ln=La to Lu, Y, Sc), and MO2 (M=Be, Mg, Ca, Sr, Ba), wherein said product nanoparticle is less than about 350 nm in diameter.

2. The lanthanide rich product nanoparticle of claim 1 wherein said lanthanide ions are selected from the group consisting of Ce, Pr, Nd, Sm, Eu, Gd, Tb, Dy, Ho, Er, Tm, Yb, La, Lu, Y and Sc.

3. The lanthanide rich product nanoparticle of claim 2 wherein said mixture comprises at least two lanthanide ions.

4. The lanthanide rich product nanoparticle of claim 2 wherein said precursor nanoparticles are core-shell nanoparticles.

5. The lanthanide rich product nanoparticle of claim 4 wherein said precursor nanoparticles comprise a metal halide salt.

6. The lanthanide rich product nanoparticle of claim 5 wherein said precursor nanoparticles comprise a metal fluoride salt.

7. The lanthanide rich product nanoparticle of claim 6 wherein said shell comprises LaF₃.

8. The lanthanide rich product nanoparticle of claim 7 wherein said precursor nanoparticles comprise LaF₃:Ln (Ln=Er, Tb, Eu, Nd, or Tm).

9. The lanthanide rich product nanoparticle of claim 8 wherein said coating is silica.

10. The lanthanide rich product nanoparticle of claim 7 wherein said precursor nanoparticles comprise MF₂:Ln (M=Be, Mg, Ca, Sr, Ba; Ln=Ce, Pr, Nd, Sm, Eu, Gd, Tb, Dy, Ho, Er, Tm, Yb).

11. The lanthanide rich product nanoparticle of claim 7 wherein said precursor nanoparticles comprise M₁M₂F₄:Ln (M₁=Li, Na, K, Rb, Cs; M₂=La, Gd, Lu, Y, Sc; Ln=Ce, Pr, Nd, Sm, Eu, Gd, Tb, Dy, Ho, Er, Tm, Yb).

12. The lanthanide rich product nanoparticle of claim 1 wherein said lanthanide rich product nanoparticles range in size from about 5 to about 150 nm in diameter.

13. The lanthanide rich product nanoparticle of claim 12 wherein said lanthanide rich product nanoparticles range in size from about 5 to about 100 nm in diameter.

14. A functionalized nanoparticle, said functionalized nanoparticle comprising:
a product nanoparticle comprising:
a precursor nanoparticle synthesized from a mixture comprising lanthanide ions; and
a coating comprising one or more of silica, alumina, zirconia, titania, hafnia, tantalum pentoxide, niobium pentoxide, germanium dioxide, Ln₂O₃ (Ln=La to Lu, Y, Sc), and MO2 (M=Be, Mg, Ca, Sr, Ba), to produce a product nanoparticle; and
a presenting substrate, said presenting substrate conjugated to said product nanoparticle for functionalizing said product nanoparticle, wherein said functionalized nanoparticle is less than about 350 nm in diameter.

15. The functionalized nanoparticle of claim 14 wherein said lanthanide ions are selected from the group consisting of Ce, Pr, Nd, Sm, Eu, Gd, Tb, Dy, Ho, Er, Tm, Yb, La, Lu, Y and Sc.

16. The functionalized nanoparticle of claim 15 wherein said mixture comprises at least two lanthanide ions.

17. The functionalized nanoparticle of claim 15 wherein said precursor nanoparticles are core-shell nanoparticles.

18. The functionalized nanoparticle of claim 17 wherein said precursor nanoparticles comprise a metal halide salt.

19. The functionalized nanoparticle of claim 18 wherein said precursor nanoparticles comprise a metal fluoride salt.

20. The functionalized nanoparticle of claim 19 wherein said shell comprises LaF₃.

21. The functionalized nanoparticle of claim 20 wherein said precursor nanoparticles comprise LaF₃:Ln (Ln=Er, Tb, Eu, Nd, or Tm).

22. The functionalized nanoparticle of claim 21 wherein said coating is silica.

23. The functionalized nanoparticle of claim 22, wherein said presenting substrate is selected from the group consisting of avidin, streptavidin, biotin, antibody, polynucleotide, lectin, protein A, polypeptides and ligands selected from the group consisting of carboxylic acids and their esters, organo phosphorous compounds and their esters, phosphonates and phosphine oxides, alcohols, thiols, sulfoxides, sulfones, ketones, aldehydes, the group consisting of polymers of carboxylic acids and their esters, organo phosphorous compounds and their esters, phosphonates and phosphine oxides, alcohols, thiols, sulfoxides, sulfones, ketones, aldehydes the group consisting of and alkyl ammonium compounds (RNH³⁺, R₁R₂NH₂⁺, R₁R₂R₃NH⁺, R₁R₂R₃R₄N⁺, where R is independently selected from alkyl and aromatic groups.

24. The functionalized nanoparticle of claim 23 wherein said presenting substrate is avidin.

25. The functionalized nanoparticle of claim 23 wherein said presenting substrate is surface modified.

26. The functionalized nanoparticle of claim 20 wherein said precursor nanoparticles comprise MF₂:Ln (M=Be, Mg, Ca, Sr, Ba; Ln=Ce, Pr, Nd, Sm, Eu, Gd, Tb, Dy, Ho, Er, Tm, Yb).

27. The functionalized nanoparticle of claim 20 wherein said precursor nanoparticles comprise M₁M₂F₄:Ln (M₁=Li, Na, K, Rb, Cs; M₂=La, Gd, Lu, Y, Sc; Ln=Ce, Pr, Nd, Sm, Eu, Gd, Tb, Dy, Ho, Er, Tm, Yb).

28. The functionalized nanoparticle of claim 14 wherein said functionalized nanoparticle range in size from about 5 to about 150 nm in diameter.

29. The functionalized nanoparticle of claim 28 wherein said functionalized nanoparticles range in size from about 5 to about 100 nm in diameter.
